(19) United States
(12) Patent Application Publication
(10) Pub. No.: US 2024/0271633 A1
(43) Pub. Date: Aug. 15, 2024

(54) EXPLOSION PROOF MOTOR, PUMP SYSTEM, AND METHOD

(71) Applicant: THE GORMAN-RUPP COMPANY, Mansfield, OH (US)

(72) Inventors: Jacob J. Berry, Uniondale, IN (US); Matthew Wenger, Fort Wayne, IN (US)

(21) Appl. No.: 18/440,308

(22) Filed: Feb. 13, 2024

Related U.S. Application Data
(60) Provisional application No. 63/445,165, filed on Feb. 13, 2023.

(51) Int. Cl. F04D 29/40; F04D 13/06; F04D 29/60

(52) U.S. Cl. CPC F04D 29/406; F04D 13/06; F04D 13/0693; F04D 29/605

(57) ABSTRACT

An explosion proof motor, pump system, and method is provided comprising a motor housing having a circular first end spaced by a cylindrical wall to a circular second end and a cavity formed therebetween within the cylindrical wall. The circular second end formed by a bell wall. The cylindrical first end and circular second end sharing a longitudinal axis that extends concentrically from the first and second ends. A pump housing having a cavity for nesting for rotational movement a rotor comprising a plurality of blades and vanes. The rotor couples to a motor shaft of the motor during use. The cavity is further formed by the cylindrical wall wherein the cylindrical wall has an inner surface and an outer surface such that the outer surface runs parallel longitudinally about the longitudinal axis and the inner surface runs transversely about the longitudinal axis.

### CROSS REFERENCES TO RELATED APPLICATIONS

The following application claims priority under 35 U.S.C. § 119(e) to co-pending U.S. Provisional Patent Application Ser. No. 63/445,165 filed Feb. 13, 2023 entitled EXPLOSION PROOF MOTOR, PUMP SYSTEM, AND METHOD. The above-identified application is incorporated herein by reference in its entirety for all purposes.

### TECHNICAL FIELD

The present disclosure generally relates to an explosion proof motor, pump system, and method thereof, and more particularly, the structure, features, and construction of the explosion proof motor and pump assembly, a method of constructing the explosion proof motor and pump assembly, and a method of operating the explosion proof motor and pump assembly.

### BACKGROUND

Fluid transfer pumps move fluid from one location to another. One example includes a pump that acts as a conduit to move fluid such as fuel from a storage tank to an internal combustion engine such as a generator and other fuel outlets throughout on-road, off-road, off-highway vehicles, and the like. The fluid transfer pump may move fluid from a storage tank to a dispensing nozzle for filling a land, marine, or snow vehicle. One example of such a pump's construction and operation is described in U.S. Pat. No. 10,590,939, which is owned by the assignee of the present disclosure. U.S. Pat. No. 10,590,939 is hereby incorporated by reference in its entirety for all purposes.

The pump may employ vanes, diaphragms, or other like structures that are rotated or oscillated inside the pump via some motive force such as an electric motor. The vanes are located in a pump enclosure that is in fluid communication with inlet and outlet manifolds.

The inlet manifold may also be in communication with the fuel in the storage tank while the outlet manifold may also be attached to a hose or other structure configured to deliver the fuel to another location. As the motor in the pump rotates the vanes, a vacuum is created in the pump enclosure to cause the fuel already present in the tank to be drawn up through the inlet manifold. The vanes then rapidly push the fuel out through the outlet manifold and the hose or fuel line, to be delivered to the other location. An electric motor is a suitable means for rotating the vanes inside the pump. The motor is also able to generate enough rotational velocity to effectively draw up and dispense the fluid at a sufficient rate.

### SUMMARY

One aspect of the present disclosure includes an explosion proof motor and pump. The motor and pump assembly includes a motor housing having a circular first end spaced by a cylindrical wall to a circular second end, a motor housing cavity formed therebetween within the cylindrical wall, the circular first end having an opening for receiving a motor, the circular second end formed by a bell wall. The cylindrical first end and circular second end share a longitudinal axis that extends concentrically from the first and second ends. The motor and pump assembly also includes a pump housing having a pump housing cavity for nesting a pump having a rotor with a plurality of blades and vanes for rotational movement, the rotor coupling to a motor shaft of the motor during use; and the pump housing cavity further formed by the cylindrical wall of the motor housing cavity, wherein the cylindrical wall has an inner surface and an outer surface, and the outer surface runs parallel longitudinally about the longitudinal axis and the inner surface runs transversely about the longitudinal axis.

Another aspect of the present disclosure includes a motor and pump assembly. The motor and pump assembly has a motor housing having a shroud forming a cavity for positioning a motor therein with an opening for receiving the motor during installation at a first end and a bell wall at a second end; a pump that when rotatably coupled to a motor provides for the transfer of fluid from the pump; a switch plate having a plurality of electrical components for providing power to a motor that is positioned in the motor housing during use, the switch plate having an exterior surface and an interior surface, the interior surface having at least one cavity for supporting the plurality of electrical components therein; a switch arm for activating the motor from an on position to an off position; a sleeve for supporting a locking bolt of a lock on the exterior surface; and an aperture located in a switch arm for the passage of the locking bolt to prevent the switch arm from moving from the off position to the on position.

Yet another aspect of the present disclosure includes a motor and pump arrangement. The motor and pump arrangement has a motor and pump housing defined by a cylindrical cavity having an opening at a first end and a bell wall at a second end, the opening for receiving a motor, a pump enclosure, and pump, such that the pump enclosure spaces the motor from the pump within the motor and pump housing. The pump has a rotor having a plurality of blades and vanes for rotational movement within a fluid passage, the rotor coupling to a motor shaft of the motor during use; and the fluid passage connecting an input passage to an output passage, wherein the fluid passage has a cammed surface for axial movement of blades and vanes during rotation of the rotor.

Yet another aspect of the present disclosure includes a method of assembling an explosion proof motor pump assembly. The method includes the steps of: providing a motor housing having a circular first end spaced by a cylindrical wall to a circular second end, forming a cavity therebetween within the cylindrical wall, the circular first end having an opening for receiving a motor, the circular second end formed by a bell wall; aligning a longitudinal axis concentrically from the first end to the second end; casting with the motor housing a pump housing having a pump enclosure with a fluid cavity for nesting a pump, the pump having a rotor having a plurality of blades and vanes for rotational movement, the rotor coupling to a motor shaft of the motor for rotational movement of the pump during use; and providing the cavity formed by the cylindrical wall such that the cylindrical wall has an inner surface and an outer surface, wherein the outer surface runs parallel longitudinally about the longitudinal axis and the inner surface runs transversely about the longitudinal axis.

Yet another aspect of the present disclosure includes an explosion proof motor housing for an explosion proof motor and pump assembly. The explosion proof motor housing includes a motor housing formed by first, second, and third volumes and first and second side walls; the first volume having a cylindrical wall sized and configured to receive a motor; the second volume having a passage to the first volume and having a mounting arrangement for a switch plate assembly; the third volume having a passage to the second volume, the second and third volumes having a plurality of openings extending through the second and third volumes for assisting in coupling a plurality of corresponding motor leads extending from the motor to a power supply coupling; wherein the first volume of the motor housing is dimensioned and configured to receive and be coupled with the motor such that at least part of the motor does not contact the cylindrical wall of the first volume or first and second side walls of the motor housing when the motor is coupled to the motor housing to create an air gap for prevention of conductive heat transfer through the cylindrical wall of the motor housing.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a front left-side perspective view of an explosion proof motor and pump assembly constructed in accordance with one embodiment of the present disclosure;

FIG. 2 is a rear perspective view of the explosion proof motor and pump assembly in an unlocked position in accordance with another example embodiment of the present disclosure;

FIG. 3 is a front right-side perspective view constructed in accordance with another example embodiment;

FIG. 4 is a top plan view of the explosion proof motor and pump assembly with the switch plate shown with the electrical switch assembly which couples to the motor housing in accordance with another example embodiment of the present disclosure;

FIG. 5 is a rear perspective view of FIG. 6;

FIG. 6 is a rear perspective view of the explosion proof motor and pump assembly in a locked position with the motor housing and switch plate, and switch shaft assembly removed to show only the motor, pump and switch lever, in accordance with another example embodiment of the present disclosure;

FIG. 7 is a side view of a pump assembly with a cover of a switch plate removed to illustrate the internal electronic components in accordance with another example embodiment;

FIG. 8 is another perspective view of the explosion proof motor and pump assembly;

FIG. 9 is another perspective view of the explosion proof motor and pump assembly;

FIG. 10 is a side elevation view of the explosion proof motor and pump assembly in an unlocked position in accordance with one example embodiment;

FIG. 11 is a side elevation view of the explosion proof motor and pump assembly in a locked position in accordance with another example embodiment;

FIG. 12 is a side elevation view thereof;

FIG. 13 is a side elevation view thereof;

FIG. 14 is a perspective view of a motor housing constructed in accordance with another example embodiment of the present disclosure;

FIG. 15 is a section view of the motor housing and a motor arrangement constructed in accordance with another example embodiment of the present disclosure;

FIG. 16 is a another perspective section view thereof;

FIG. 17 is a side elevation section view thereof;

FIG. 18 is a magnified view of a portion of FIG. 17;

FIG. 19 is a magnified view of a portion of FIG. 17;

FIG. 20 is an end view illustrating the pump vanes of the explosion proof motor and pump assembly in accordance with another example embodiment;

FIG. 21 is a perspective view thereof;

FIG. 22 is a top plan view thereof;

FIG. 23 is a perspective view thereof;

FIG. 24 illustrates an upper perspective view of an explosion proof motor and pump assembly in accordance with another example embodiment of the present disclosure; and

FIG. 25 illustrates a lower perspective view thereof.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure. Further, the utility and purpose of many structures are shown in the figures are described throughout the specification. However, it should be appreciated that some of the structures shown in the figures have been selected or invented for aesthetic appearance and ornamental design independent of its utilitarian operation or lack thereof.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures wherein like numbered features shown therein refer to like elements throughout unless otherwise noted. The present disclosure relates generally to an explosion proof motor and pump system, and method thereof, and more particularly, the features, structures, and construction of the explosion proof motor and pump assembly, the method of constructing an explosion proof motor and pump assembly, and a method of operating the explosion proof motor and pump assembly.

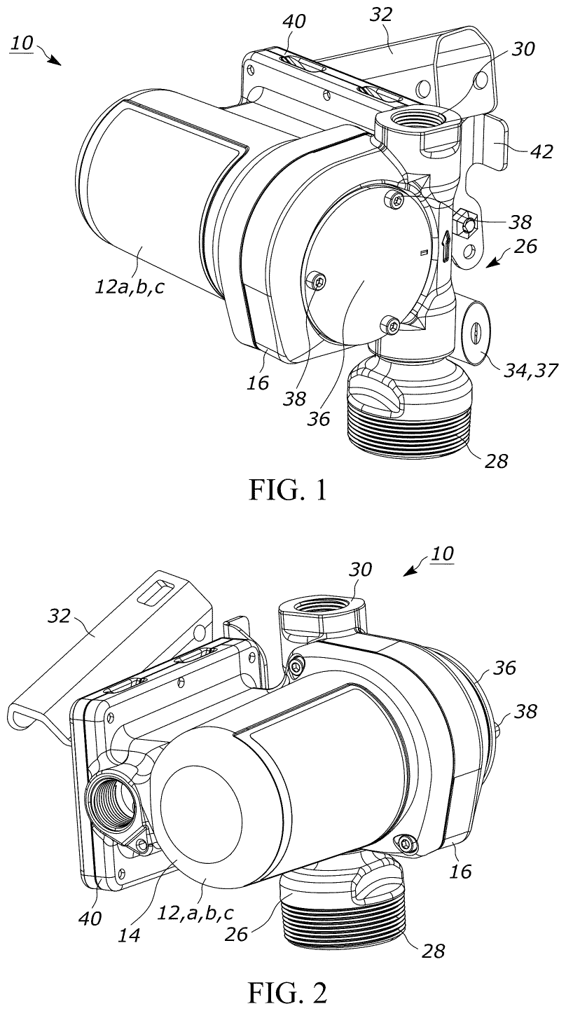

In FIG. 1, a front perspective, pump facing view of one embodiment of an explosion proof motor and pump assembly 10 is shown. Externally, the pump assembly 10 features an explosion proof motor enclosure or housing 12, end bell 14, and pump enclosure 16 which prevent any sparks or flames from escaping the motor housing 12.

In one example embodiment, the explosion proof motor and pump assembly 10 includes a motor 18 coupled to a rotor 22 and vane assembly 22 (see FIG. 20) to form a pump arrangement 24 which operates to transfer fluids such as water or fuel from a first location to a second location. In one example embodiment, the explosion proof motor and pump assembly 10 transfers fluids from a first location comprising a storage tank (not shown) to a second location comprising an internal combustion motor (not shown), such as a generator. In another example embodiment, the pump assembly 10 transfers fluids from a first location comprising a storage tank through a manifold 26 that is in fluid communication with the pump arrangement 24 such that fluid is pulled from the supply or storage tank into an input port 28 through the manifold 26 to an output port 30, and into a second location. The input and output ports 28, 30, respectively, in another example embodiment, are coupled to a supply hose (not shown), wherein the supply hose to the output port 30 is coupled to a dispensing nozzle (not shown) for filling another tank, such as a tank to an automobile or farm implements, tractors, marine vehicles, all terrain vehicles, recreational vehicles, and the like. The nozzle to the supply hose, when not in use, is supported by a nozzle holster 32.

In the illustrated example embodiment, the pump 10 has a volumetric flow rate between one gallon per minute to sixteen gallons per minute, and typically approximately eight gallons per minute. However, it should be appreciated by those of ordinary skill in the art that greater and smaller volumetric flow rates motor, pump arrangements, and vane/rotor combinations can be used without departing from the scope and claims of the present disclosure after having the benefit of this specification and associated figures.

In the illustrated example embodiment, the explosion proof motor and pump assembly 10 is a class 1 division 2 assembly constructed from cast metals such as aluminum and machined to be assembled into a complete assembly with moving components. In another example embodiment, the assembly is all or in portion zinc plated, painted, or any combination thereof. The motor 18 in one example embodiment is provided power through a cable (not shown) extending from a power supply coupling 34 in such a way that it maintains a class 1 division 2 construction and the explosion proof pump assembly 10 typically weighs between 10 to 11 pounds. One of ordinary skill in the art would also understand that the weight of the pump assembly may vary.

In another example embodiment, the explosion proof motor housing 12 is made from metal, such as aluminum on steel casting with subsequent machining operations to make a tapered cavity 70. The tapered cavity 70 could also be cast into the housing 12 without any further machining operations.

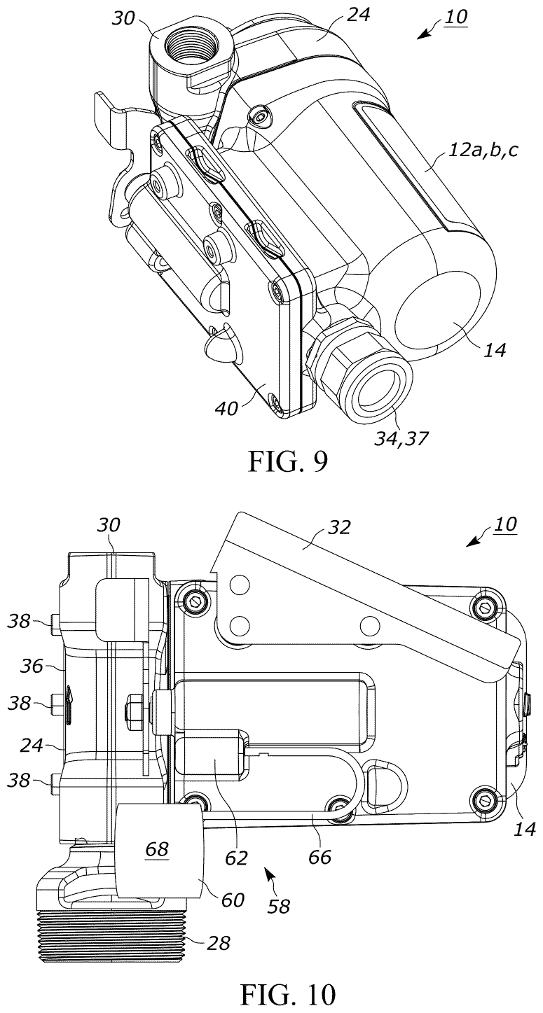

As shown in FIG. 9, in this illustrated example embodiment of the present disclosure, an oversized cable gland 37, allows for a significant set of advantages. One such advantage is that the manufacturer can paint the completed pump assembly 10 without first attaching a power cable. This eliminates masking and the need for additional labor to perform said actions, and is achieved by using a cable gland assembly 37 that is large enough to allow the motor lead 48 power supply coupling 34 to pass through the cable gland assembly 37. This embodiment also provides further advantages relating to safety and ease of use. For example, the user may remove, service or modify an attached power cable without removing the switch plate assembly 40. This switch plate assembly 40 forms a part of the safety construction of the motor housing 12 assembly by providing the necessary flame paths to achieve an explosion proof motor enclosure and assembly 10. This ensures that no damage occurs to these safety features. This also allows the possibility for the manufacturer to make a class 1 division 1 rated motor assembly that customers can choose to use in a class 1 division 2 application without having to remove the switch plate assembly 40. In addition, the function of the switch actuator mechanism and the electrical switch will not be mis-assembled by a customer. The primary difference in construction for a brushed motor-based device is in what is allows for the power supply coupling 34 mechanism.

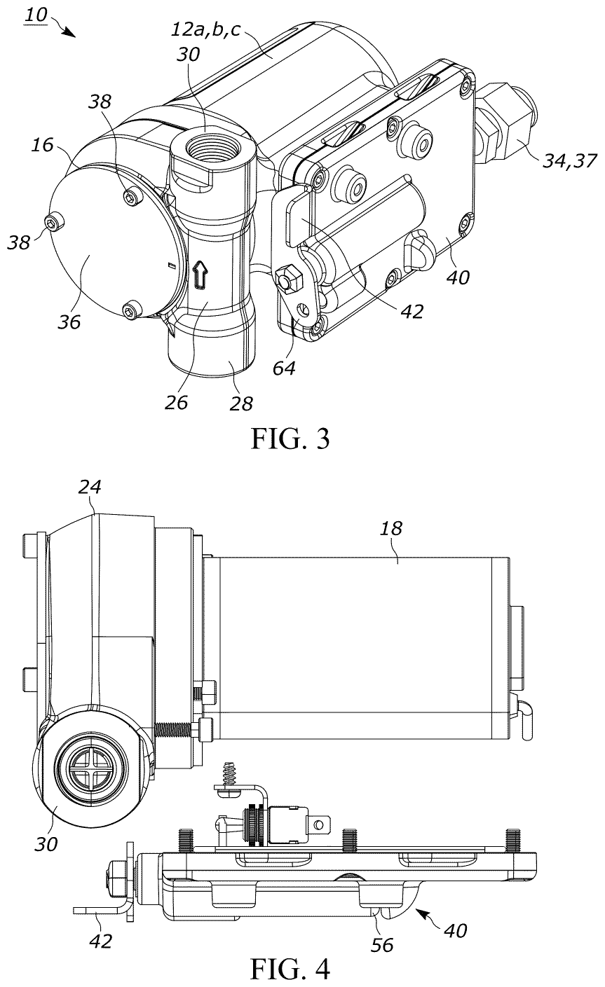

In the illustrated example embodiment of FIGS. 1-3, the pump assembly 10 further includes a removable end cap 36 that coupled to the pump enclosure 16 via fasteners 38. The removal of the end cap 36 allows a user access to the vane assembly 22, rotor 22, and pump arrangement 24 for maintenance and repair/replacement.

The explosion proof motor and pump assembly 10 further comprises a switch plate arrangement 40 for enabling the pump assembly 10 to shift from an on and off state to the motor 18, which rotates the pump arrangement 24 such that the transfer of fluid occurs along a flow path from the input port 28 to the output port 30. The switch plate arrangement 40 receives its power from a supply power cable (not shown) that is adapted to the power supply coupling 34. The switch plate arrangement 40 includes a lever arm 42 fastened to a switch shaft 44 that is coupled to a position switch 46 that includes motor lead 48 power supply coupling 34 that passes through the cable gland assembly 37, as would be appreciated by one of ordinary skill in the art with the benefit of the subject specification and associated figures.

In this example embodiment, the leads 48 that are in electrical communication with the power coming from the power supply coupling 34 are all mounted to the motor housing 12 and only the mechanical switch lever arm 42 is attached to the switch shaft 44 of switch plate arrangement 40. The motor housing 12 has a plurality of main volumes, in this example embodiment, 3 volumes, the first of which 12a is the approximately cylindrical volume comprising a cavity wherein the motor 18 will reside. The second volume 12b is connected to the first volume 12a and contains a mounting provision for the switch plate arrangement 40 and space for connecting the leads 48 to the switch shaft 44 and motor 12. The third volume 12c is the field wiring compartment or junction box that forms a coupling between the motor leads 48 and the power supply coupling 34. The motor leads 48 pass through small openings formed within the motor housing 12 that connect second volume 12b and third volume 12c. These leads 48 are subsequently sealed and secured between second volume 12b and third volume 12c by a sealant material such as epoxy or cement.

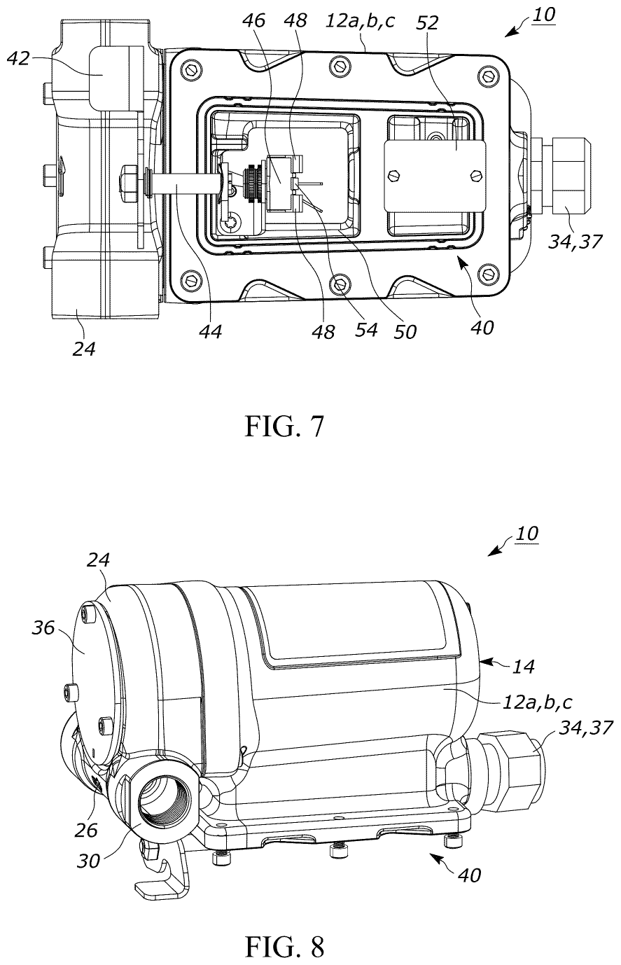

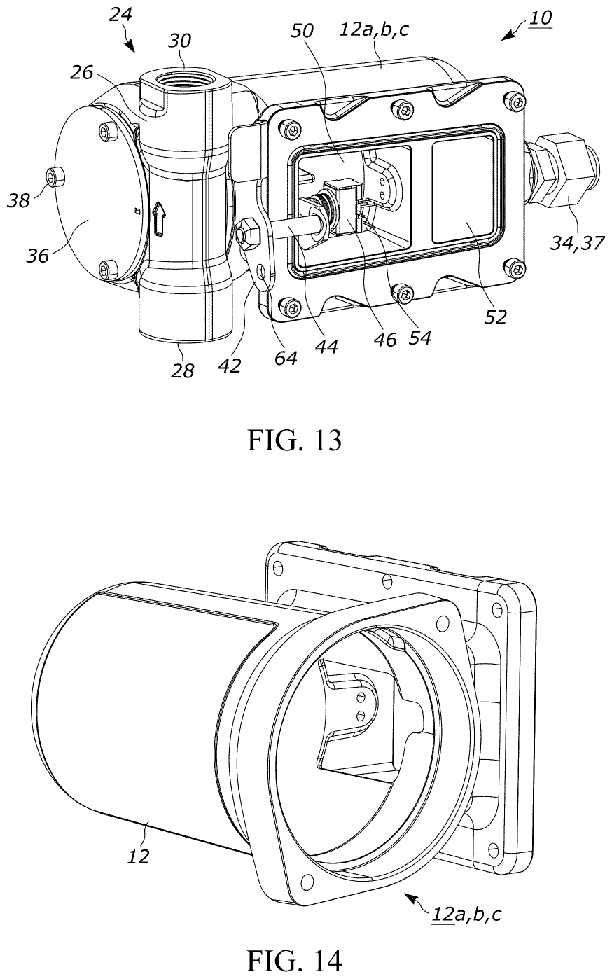

The switch 46 and leads 48 reside in a first chamber 50 of the switch plate 40, isolated by the switch or lever arm 42 that is external to the first chamber 50. The switch shaft 44 in the illustrated example embodiment runs parallel with a motor shaft 20 and is rotatably connected and/or coupled between the switch 46 and lever arm 42 as it passes externally into the first chamber 50. A second chamber 52 is adjacent the first chamber 50 within the switch plate arrangement 40. The second chamber 52 includes a passage extending from the first chamber 50 for a housing a wiring harness 54 formed by wires connected to the leads 48 of the switch 46. A cover 56 from the switch plate arrangement 40 is removed in FIGS. 7, 12 and 13 so that the chambers 50, 52 and internal components are shown.

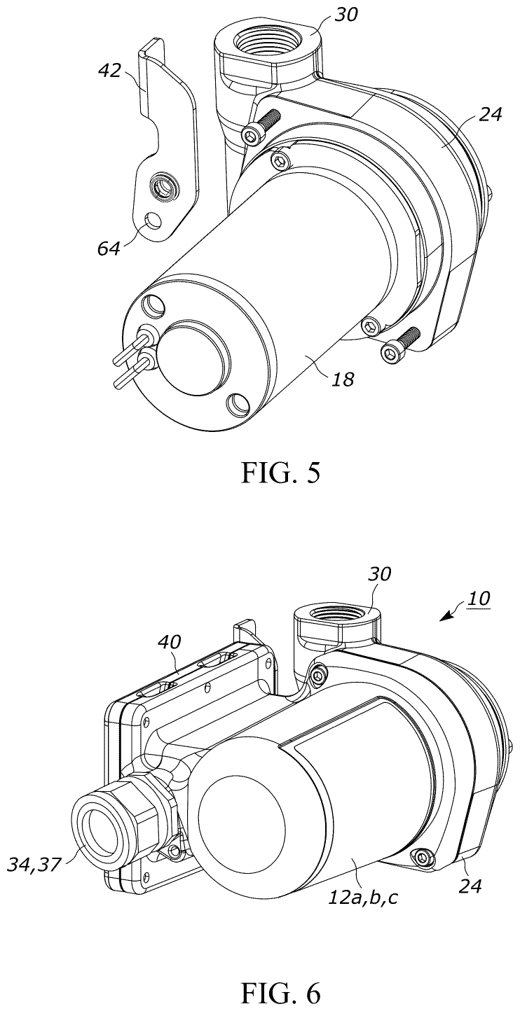

Within the second chamber 52 the wiring harness 54 is coupled to power supply coupling 34 that passes through the cable gland assembly 37. The construction and components located within the first and second chambers 50, 52, respectively form a class 1 division 2 explosion proof assembly. In one example embodiment, the switch plate assembly 40 is removed (see FIGS. 4 and 5) so that the explosion proof pump assembly 10 can be used with a cover plate (not shown) to form an OEM operation, utilizing the advantages of the explosion proof construction of the pump arrangement 24 and pump enclosure 16 as previously discussed and further discussed herein.

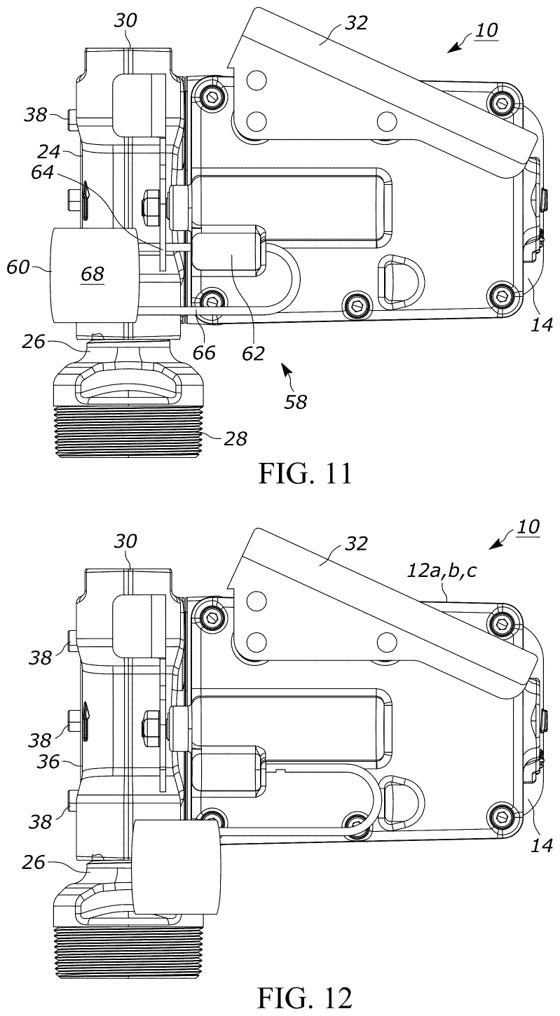

As seen in FIG. 6, operation of the explosion proof motor and pump assembly 10 can be regulated by a locking assembly 58 formed by a lock 60, a sleeve 62 that is molded or cast into the switch plate arrangement 40, and an aperture 64 in the lever arm 42. FIG. 10 shows the locking assembly 58 in an unlocked position, where, in this example embodiment, the lock 60 includes a bolt 66 that is disengaged from a body 68 of the lock 60 and the aperture 64 of the lever arm 42, allowing the lever arm to have rotational capacity, with initiation of rotation activating the switch 46, motor 18, and pump arrangement 24. In another example embodiment illustrated in FIG. 11, the locking assembly 58 shows the passage of the bolt 66 through the aperture 64, prohibiting the rotation of the lever arm 42 and, thus, the activation of the pump arrangement 24 and motor 18.

In the prior art, conventional nozzle pumps have been designed to lock the actual nozzle, which causes congestion around the pump, inhibits operation by the user, and limits access of wrenches for bolts and fasteners, lost locks, and the like. Advantageously, the locking assembly 58 described and shown in the present disclosure opens the area around the pump for ease of maintenance and access. The lock 60 is also advantageously retained in the sleeve 62 when in an unlocked position, preventing lost or misplaced locks after use that often occurs in traditional pump systems.

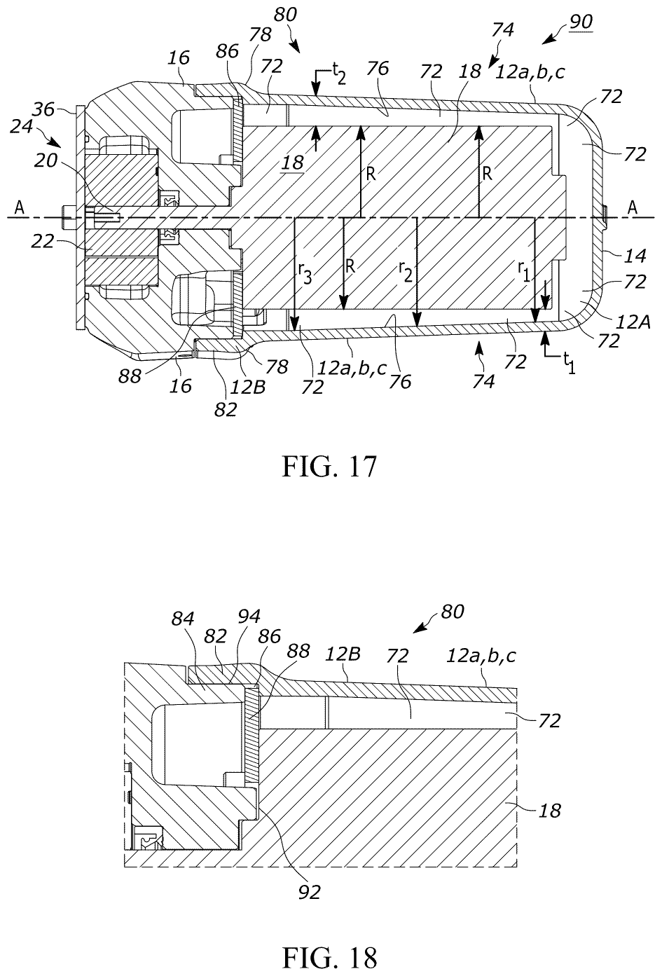

Illustrated in the example embodiment of FIGS. 16 and 17 is a cross-sectional view of the pump enclosure 16, motor 18, and pump arrangement 24. The pump enclosure 16 is advantageously constructed to support multiple types, shapes, and sizes of motors 18 for unlimited applications. Such construction of the pump enclosure 16 further allows for replacement motors of many different brands and types to be used when the original or replacement motor is worn or inoperable. This improves manufacturer ability to source motors from multiple suppliers to improve supply chain robustness but does not allow for customers to replace motors or motor components. The construction of the pump enclosure 16 allows for controlled displacement of heat from the motor 18, keeping the surface of the enclosure 16 relatively cool to the touch compared to the outer surface of the pump motor 18. This provides a safety benefit, when compared to a conventional motor construction where the exterior parts of the motor 12 are directly accessible to the end user.

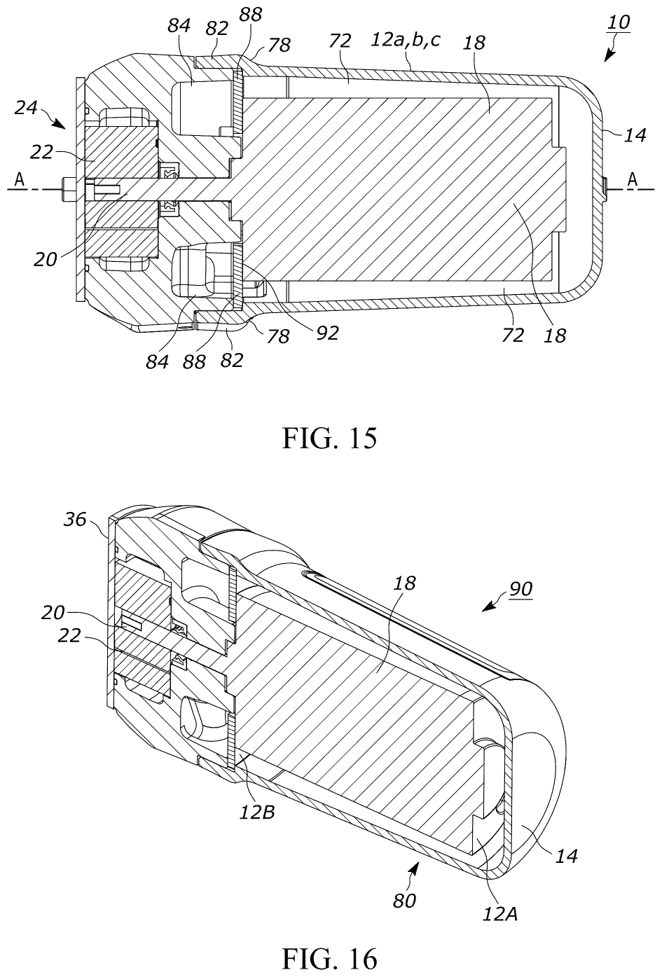

As shown in FIGS. 15-17, a main assembly 90 contributes as one factor to the efficient heat exchange and versatility of the motor 18 of the pump 10. The main assembly 90 is formed by the coupling of the motor housing 12 to the pump enclosure 16 as shown in cross sectional views of FIGS. 16 and 17. The motor housing 12 includes a hollow cavity 70 substantially cylindrically formed about a central axis A-A. The central axis A-A of the cavity 70 is concentrically aligned with a central axis of the motor 18 and motor shaft 20. An air gap 72 is formed between the motor 18 and the motor housing 12. The air gap 72 is formed around the cylindrical perimeter of the motor 18 such that the motor 18 is not in physical contact with the motor housing 12, thus preventing conductive heat transfer between the motor 18 and housing 12. Advantageously, this keeps the surface temperature of the motor 12 substantially lower than conventional designs, and creates a safety benefit for the user.

Also assisting in the dissipation of heat is the frustoconical shape 80 of the cavity 70 about axis A-A. As illustrated in FIG. 17, a motor 18 of a constant radius R is shown with a central axis shared and concentric with housing 12 axis A-A. A cylindrical taper 74 is concentrically formed about the cavity's 70 interior wall 76 about axis A-A such that a first end 12A of the housing 12 has a radius r1 that extends to the cavity wall 76 and a second end 12B of the housing has a radius r3 that extends to the cavity wall 76, wherein r3 is greater than r1 in this example embodiment of the present disclosure. A radius r2 is taken anywhere between said first end 12A and said second end 12B such that r3 is greater than r2 which is greater than r1. In one example embodiment, the cylindrical taper 74 is substantially linear between first end 12A and second end 12B. Stated another way, a thickness in the air gap 72 is smaller at the first end 12A, as designated by t1, than a thickness in the air gap 72 at the second end 12B, designated by t2. Thus, the frustoconical interior wall 76 of cavity promotes convective heat transfer away from the motor 18 and housing 12 and toward the pump enclosure 16.

The air gap 72 also permits varying size motors 18 so that different pumps can be used for varying applications and can be easily replaced with different brands and physical sizes from prior and subsequent motors. In the illustrated example embodiment, the air gap 72 is substantially a constant in a plane parallel with the end bell 14 between the motor 18 and housing 12. The air gap in this area can increase in space to accommodate longitudinally longer motors without departing from the spirit and scope of the present disclosure.

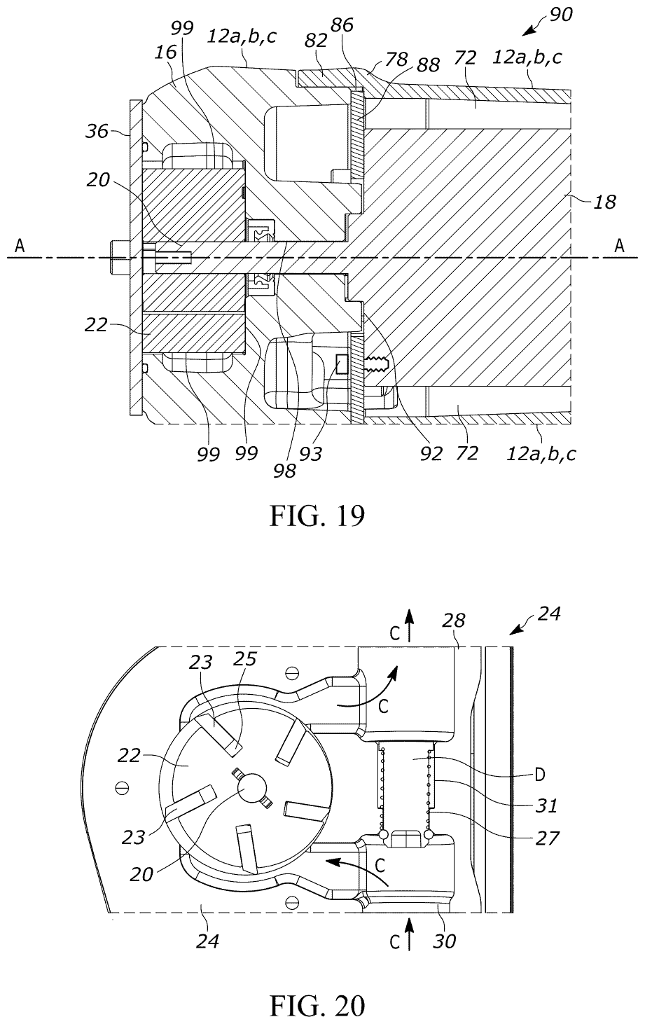

Referring again to FIG. 17 it is illustrated that the main assembly 90 is formed in part by a cylindrical step 78 in the motor housing 12 at second end 12B that is an increased lateral diameter than that about the motor cavity 70. In one example embodiment, this step 78 includes a cylindrical flange 82 that is seated over a cylindrical nest 84 formed from or cast into the pump housing 16. A cylindrical slot 86 is formed between the cylindrical nest 84 and flange 82 such that one or more cylindrical keepers 88 are fastened with fasteners 93 to a forward face 92 of the motor 18 as illustrated in FIGS. 15, 18, and 19. Extending from the step 78 along the flange 82 are interior threads 94A for mating and connecting with exterior threads 94B formed on the cylindrical nest 84. When the cylindrical slot 86 is reduced to the thickness of the keepers 88, the pump housing 16 is secured to the motor housing 12 to form a main assembly 90.

The main assembly 90 is formed by inserting a motor 18 into the motor housing 12 to form the air gap 72 around the cylindrical perimeter and end of the motor 18. Keepers 88 of cylindrical or linear shape having a selectable thickness are attached to the face 92 of the motor 18 with fasteners 93. The pump housing 16 is advanced so that the exterior threads 94B engage interior flange 82 threads 94A and the pump housing 16 is rotated relative to the motor housing 12 until the cylindrical slot 86 is reduced to the thickness of the keeper(s) 88 forming a tight connection 95 between the housings to form the main assembly 90. This connection 95 forming the main assembly 90 draws convective heat from the air gap 72 and conductive heat from the motor 18 face 92 through the keepers 88 such that desirable heat transfer occurs from the motor cavity 12 into the pump housing 16, and then into the fluid being transferred when the pump 10 is in operation. In one example embodiment, the main assembly 90 contains ribs and/or additional features to help promote efficient heat transfer.

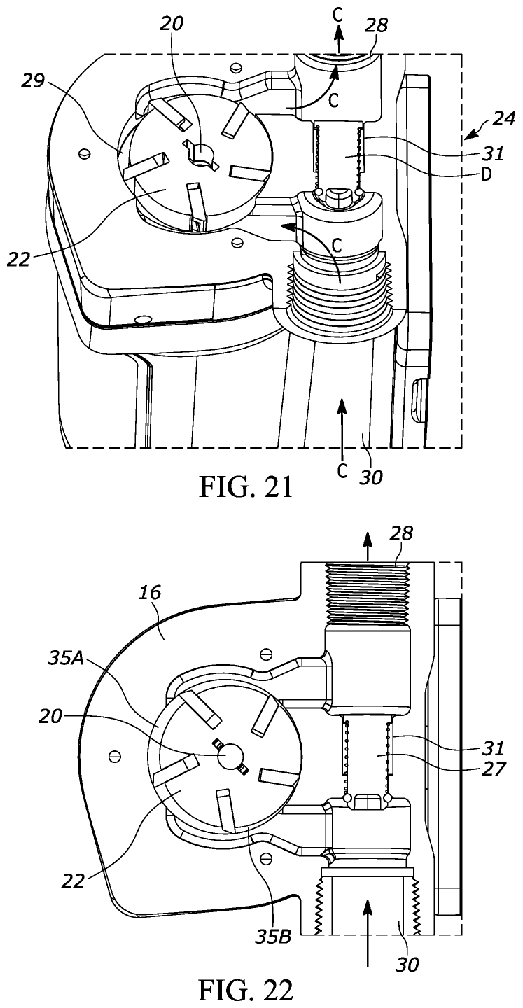

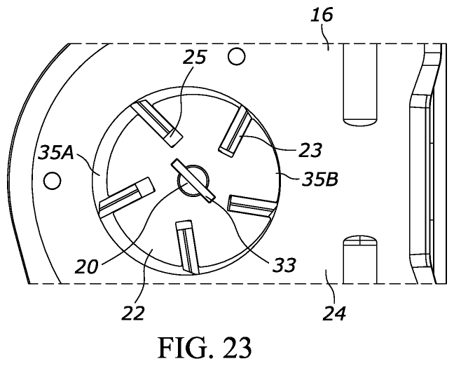

The pump housing 16 incudes a main bore 98 for coupling with the motor shaft 20 and rotor cavity 99, thus providing relief for the pump assembly 10. The pump housing 16 advantageously supports the internal components of the pump assembly 10 without use of a traditional straight wall bore or rear bearing assembly. Moreover, in one example embodiment of the present disclosure, the motor housing 12 and pump housing 16 comprise die cast housings, which allow for the addition of other desired features in its manufacture. Traditionally, a motor and pump housing features a stator in tube form which does not allow for additional details to be added in its manufacture because the stator frame is an external housing and completes the magnetic circuit. The pump assembly 24 of the present disclosure does not utilize a stator frame, and, thus, allows for the addition of additional features such as inlets and passages as shown in FIGS. 20-23.

Referring now to FIGS. 20-23, the pump arrangement 24 is shown without end cap 36. The pump arrangement 24 includes the rotor 22, movable blades 23 positioned within respective vanes 25, a bypass valve 27, a cam channeled profiled fluid passage 29, a bypass passage 31, motor shaft rotor key 33, and cam surface 35. The motor shaft rotor key 33 couples the rotor 22 to the motor shaft 20 such that rotation of the motor 18 rotates the rotor 22 at the same time and rate as the motor 18 itself. During rotation of the rotor 22, the blades 23 move in and out of their respective vanes 25 until contacting the cammed surface 35 of the channeled profiled fluid passage 29. The blades move outward to push water when the passage is wide 35A and contract when the passage is narrow 35B, advancing fluid from the output port 28 along a flow path to the input port 30 (see arrows C).

When the fluid pressure is too high, the bypass valve 27 opens and allows a percentage of all flow to be returned to the inlet side of the pump. The bypass valve 27 permits the transfer of fluid without the operation of the pump arrangement 24 and motor 18.

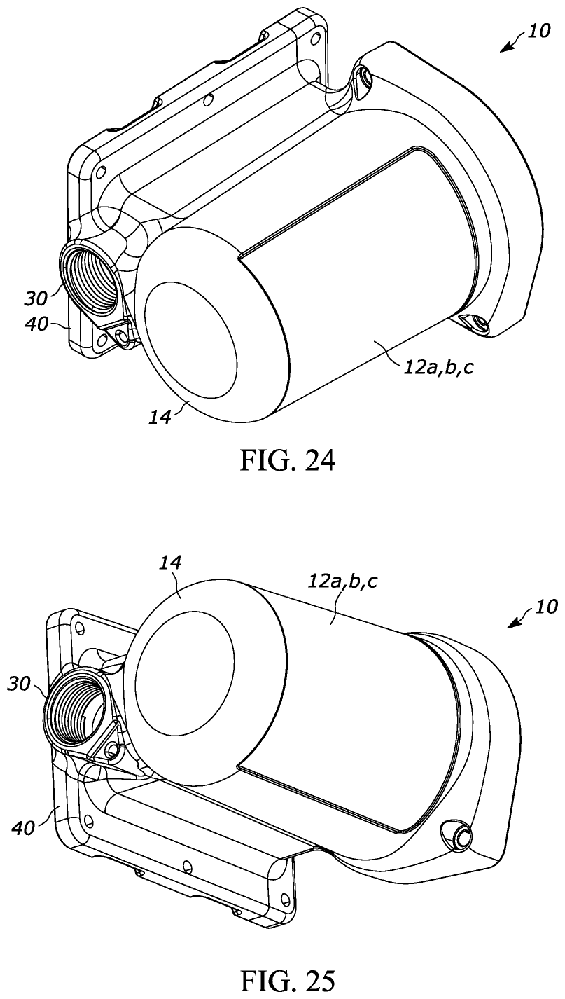

FIGS. 24-25 illustrate another example embodiment of an explosion proof motor and pump assembly, including both technical and ornamental features in their perspective views in accordance with another example embodiment of the motor housing 12 of the present disclosure.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, . . . Eₙ and that each embodiment E may have multiple parts A₁, B₁, C₁ . . . . Zₙ that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A motor and pump assembly comprising:
a motor housing comprising a circular first end spaced by a cylindrical wall to a circular second end, a motor housing cavity formed therebetween within said cylindrical wall, the circular first end having an opening for receiving a motor, the circular second end formed by a bell wall;
the cylindrical first end and circular second end sharing a longitudinal axis that extends concentrically from said first and second ends;
a pump housing comprising a pump housing cavity for nesting a pump having a rotor comprising a plurality of blades and vanes for rotational movement, the rotor coupling to a motor shaft of said motor during use; and
said pump housing cavity further formed by said cylindrical wall of said motor housing cavity, wherein said cylindrical wall has an inner surface and an outer surface, wherein said outer surface runs parallel longitudinally about said longitudinal axis and said inner surface runs transversely about said longitudinal axis.

2. The motor and pump assembly of claim 1 wherein said inner surface forms a frustoconical cavity.

3. The motor and pump assembly of claim 1 wherein said inner wall surface includes a tapered wall thickness from said cylindrical first end to said cylindrical second end.

4. The motor and pump assembly of claim 1 wherein said motor housing cavity forms an air gap between said motor and said inner wall surface of said motor housing to dissipate heat of the motor during operation.

5. The motor and pump assembly of claim 1 further comprising a switch plate cavity wherein said motor housing and said switch plate cavity are formed from a single metal casting.

6. The motor and pump assembly of claim 1 further comprising a pump enclosure that separates the placement of said motor within said motor housing from said pump to form an explosion proof motor pump assembly.

7. The motor and pump assembly of claim 1 further comprising a cable gland assembly for providing a passage of a power cable to a plurality of electrical components within a switch plate cavity that is enclosed by a switch plate cover to collectively form an explosion proof motor and pump assembly.

8. A motor and pump assembly comprising:
a motor housing comprising a shroud forming a cavity for positioning a motor therein with an opening for receiving the motor during installation at a first end and a bell wall at a second end;
a pump that when rotatably coupled to a motor provides for the transfer of fluid from the pump;
a switch plate comprising a plurality of electrical components for providing power to a motor that is positioned in said motor housing during use, the switch plate having an exterior surface and an interior surface, the interior surface having at least one cavity for supporting said plurality of electrical components therein;
a switch arm for activating said motor from an on position to an off position;
a sleeve for supporting a locking bolt of a lock on said exterior surface; and
an aperture located in a switch arm for the passage of said locking bolt to prevent said switch arm from moving from said off position to said on position.

9. The motor and pump assembly of claim 8 wherein said motor housing and said switch plate interior surface are formed from a single metal casting.

10. The motor and pump assembly of claim 8 further comprising a pump enclosure that separates the placement of a motor within said motor housing from said pump to form an explosion proof motor and pump assembly.

11. The motor and pump assembly of claim 9 further comprising a pump enclosure that separates the placement of a motor within said motor housing from said pump to form an explosion proof motor and pump assembly.

12. The motor and pump assembly of claim 8 further comprising a cable gland assembly for providing a passage of a power cable to said plurality of electrical components within said cavity that is enclosed by a switch plate cover to collectively form an explosion proof motor assembly.

13. The motor pump assembly of claim 8 further comprising a motor.

14. The motor and pump assembly of claim 8 wherein said pump is formed by a pump enclosure formed by a fluid passage for supporting the rotational movement of a rotor of said pump, said fluid passage having a further comprising a fluid passage having acammed surface for axial movement of blades and vanes of said rotor during rotation thereof.

15. A motor and pump arrangement comprising:
a motor and pump housing defined by a cylindrical cavity having an opening at a first end and a bell wall at a second end, the opening for receiving a motor, a pump enclosure, and pump, such that said pump enclosure spaces said motor from said pump within said motor and pump housing;
said pump having a rotor comprising a plurality of blades and vanes for rotational movement within a fluid passage, the rotor coupling to a motor shaft of said motor during use; and
said fluid passage connecting an input passage to an output passage, wherein said fluid passage comprises a cammed surface for axial movement of blades and vanes during rotation of said rotor.

16. The motor and pump assembly of claim 15 further comprising a bypass valve positioned between said input passage and said output passage.

17. The motor and pump assembly of claim 15 further comprising a pump enclosure having a fluid passage for supporting said rotor and an inlet channel in fluid communication with said fluid passage and said input passage, and said pump enclosure further comprising an outlet channel in fluid communication with said fluid passage and said outlet passage.

18. A method of assembling an explosion proof motor pump assembly comprising the steps of:
providing a motor housing comprising a circular first end spaced by a cylindrical wall to a circular second end, forming a cavity therebetween within said cylindrical wall, the circular first end having an opening for receiving a motor, the circular second end formed by a bell wall;
aligning a longitudinal axis concentrically from said first end to said second end;
casting with said motor housing a pump housing having a pump enclosure with a fluid cavity for nesting a pump, the pump comprising a rotor having a plurality of blades and vanes for rotational movement, the rotor coupling to a motor shaft of said motor for rotational movement of said pump during use; and
providing said cavity formed by said cylindrical wall such that said cylindrical wall has an inner surface and an outer surface, wherein said outer surface runs parallel longitudinally about said longitudinal axis and said inner surface runs transversely about said longitudinal axis.

19. The method of claim 18 further comprising the step of forming said inner cavity to be a frustoconical cavity.

20. The method of claim 18 further comprising the step of tapering the inner wall surface from said first end to said cylindrical second end.

21. The method of claim 18 further comprising the step of forming an air gap with said cavity between said motor and said inner wall surface of said motor housing to dissipate heat of the motor during operation.

22. The method of claim 18 further comprising the step of providing a switch plate cavity wherein said motor housing and said switch plate cavity are formed from a single metal casting.

23. The method of claim 18 further comprising the step of providing a pump enclosure that separates the placement of said motor within said motor housing from said pump to form an explosion proof motor and pump assembly.

24. The method of claim 18 further comprising the step of providing a cable gland assembly to form a passage for a power cable to a plurality of electrical components within a switch plate cavity that is enclosed by a switch plate cover to collectively form an explosion proof motor and pump assembly.
